(19) United States
(12) Patent Application Publication
(10) Pub. No.: US 2024/0384812 A1
(43) Pub. Date: Nov. 21, 2024

(54) Interchangeable Linear Power Module

(71) Applicant: VRG Controls LLC, Lake Zurich, IL (US)

(72) Inventors: Vladimir Rimboym, Highland Park, IL (US); James M. Garvey, Glen Ellyn, IL (US)

(21) Appl. No.: 18/667,341

(22) Filed: May 17, 2024

Related U.S. Application Data
(60) Provisional application No. 63/503,019, filed on May 18, 2023.

(51) Int. Cl. F16K 31/122; F16K 31/02; F16K 31/44

(52) U.S. Cl. CPC F16K 31/122; F16K 31/02; F16K 31/44

(57) ABSTRACT

A system of interchangeable linear power modules for modulating crank arm actuators for above and below ground applications is disclosed. Electric and electro-hydraulic (E/H) actuators are used as direct replacement for pneumatic linear and quarter-turn actuators that utilize electro-pneumatic and pneumatic control instrumentation. For “below ground” and “above ground” control valve applications that utilize “crank arm” type actuators, existing pneumatic actuator may be replaced with a linear version of an electro-hydraulic or hydraulic actuator. This permits easy replacement of pneumatic actuator power modules with one of either electro-hydraulic or electric actuator power modules, thereby eliminating associated fugitive emissions.

### RELATED APPLICATION

The present disclosure claims the filing priority of U.S. Provisional Application No. 63/503,019, titled “Interchangeable Linear Power Module” and filed on May 18, 2023. The '019 application is hereby incorporated by reference.

### TECHNICAL FIELD OF THE INVENTION

The present invention relates to natural gas controllers. More specifically, the invention relates to a system of interchangeable linear power modules for modulating crank arm actuators for below and above ground applications. Most specifically, preferred actuators are hydraulic and electro-hydraulic.

### BACKGROUND OF THE INVENTION

Control valve manufacturers in the natural gas industry have been applying pneumatic modulating crank arm actuators for years in tandem with pneumatic and electro-pneumatic control instrumentation. The crank arm actuators are used to operate the fluid control valves positioned in natural gas supply lines. Such a fluid control valve is illustrated in U.S. Pat. No. 8,366,070 to Rimboym et al. titled “Fluid Control Valve” and issued Feb. 5, 2013. The '070 patent is hereby incorporated by reference. Because these control valves use natural gas in the pneumatics, systems of most manufacturers expel a significant amount of natural gas to atmosphere on a constant basis—even during steady state operation. These emissions have been deemed harmful to the atmosphere and are believed to lead to other negative issues. VRG Controls, Applicant and Assignee of the present disclosure, offers an array of industry leading technologies that feature “zero steady state” emissions that cut overall natural gas emissions significantly. However, the natural gas industry is being mandated to completely eliminate all atmospheric emissions.

As one solution, VRG Controls offers a unique control valve whereby gas emissions from pneumatic and electro-pneumatic control systems are captured within the process piping and atmospheric emissions are completely eliminated. However, not all control valve applications are suitable for the “captured gas emissions” and are thereby forced to discharge natural gas to the atmosphere as emissions. Accordingly, where the VRG Control “captured gas emissions” feature cannot be incorporated to the pneumatic control system, alternative solutions must be implemented.

Electric and Electro-Hydraulic Actuators are available as a direct replacement for pneumatic quarter turn actuators that utilize electro-pneumatic and pneumatic control instrumentation. Typically, existing electric and electro-hydraulic (EH) actuators are offered in a “quarter turn” format for direct installation on the valve stem (see '070 Patent). However, where below ground crank arm applications are utilized, direct replacement with these “quarter turn” electric and electro-hydraulic actuators is not possible as the valve stem is not accessible—i.e., it is below ground (see FIG. 2).

Accordingly, in order to eliminate emissions, a replacement for below ground crank arm applications for valves using pneumatic and electro-pneumatic control modules are needed. Further, such a replacement power module that could be used for above ground applications as well would provide greater efficiency.

Applicant has found that for pneumatic “below ground” and “above ground” control valve applications that utilize “crank arm” type actuators, the existing pneumatic actuator power module may be replaced with a linear version of an electro-hydraulic or hydraulic actuator. The replacement of the “pneumatic actuator power module” with an electro-hydraulic or electric “actuator power module” thereby eliminates associated fugitive natural gas emissions. However, as there are features and benefits to keeping the “crank arm” components of the pneumatic actuator, replacement quarter-turn electro-hydraulic and electric actuators which connect directly to the valve stem are less desired.

Until the invention of the present application, these and other problems in the prior art went either unnoticed or unsolved by those skilled in the art. The present invention provides interchangeable linear modules which perform with the associated crank arm device without sacrificing features of effectiveness and accuracy.

### SUMMARY OF THE INVENTION

There is disclosed herein an improved natural gas modulating system which avoids the disadvantages of prior devices while affording additional structural and operating advantages.

Generally speaking, the system is for modulating a control valve having a fluid pathway connecting an inlet to an outlet, a rotatable ball positioned within the fluid pathway and having an opening therethrough to align with the fluid pathway, and a valve stem connected to the ball, extending to an exterior of the control valve and configured to rotate the ball within the control valve to thereby affect the alignment of the opening with the fluid pathway. Specific embodiments of the system comprise a torque arm (also referred to as “crank arm” herein) mechanism connected by a first end to the valve stem of the control valve, and a linear actuator having a piston configured to move along a line normal to an axis of the valve stem, the piston connected to a second end of the torque arm mechanism such that linear movement of the piston causes rotational movement of the first end of the torque arm mechanism and the connected valve stem. The linear actuator operates to move the piston along the line normal to the axis of the valve stem and thereby alter the alignment of the opening of the rotatable ball with the fluid pathway.

In specific embodiments, the system control valve is positioned below ground and the linear actuator is positioned above ground. Alternatively, the linear actuator comprises an electric linear actuator or an electro-hydraulic linear actuator. These actuator modules, including a pneumatic actuator module, are interchangeable.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a schematic of an above-ground natural gas controller 110 including a pneumatic linear valve actuator module 100;

FIG. 2 is a schematic of a below-ground natural gas controller 110 having a pneumatic linear valve control actuator module 100;

FIG. 3A is a schematic illustrating an embodiment of the interchangeable linear power module system as described herein for above ground applications;

FIG. 3B is an embodiment of a preferred crank-arm for connection to the valve stem of the gas line control valve;

FIG. 4 is a schematic illustrating an embodiment of interchangeable linear power modules for modulating crank arm actuators for above ground applications;

FIG. 5 is a schematic illustrating an embodiment of interchangeable linear power modules for modulating crank arm actuators for below ground applications;

FIG. 6 is a schematic illustrating an embodiment of a control valve assembly with electro-hydraulic actuator thrust assembly;

FIG. 7 is a schematic showing an alternate control assembly with an electro-hydraulic (E/H) unit engaged and a pneumatic override controller, which is not engaged; and

FIG. 8 is the same schematic as FIG. 7 illustrating a power “off” condition and the pneumatic override controller engaging to take control of the gas line control valve.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

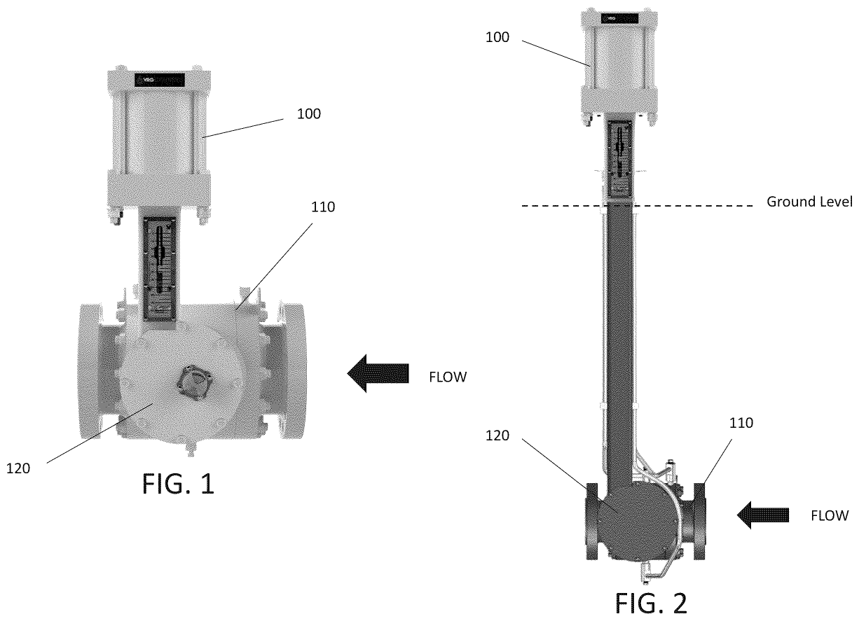

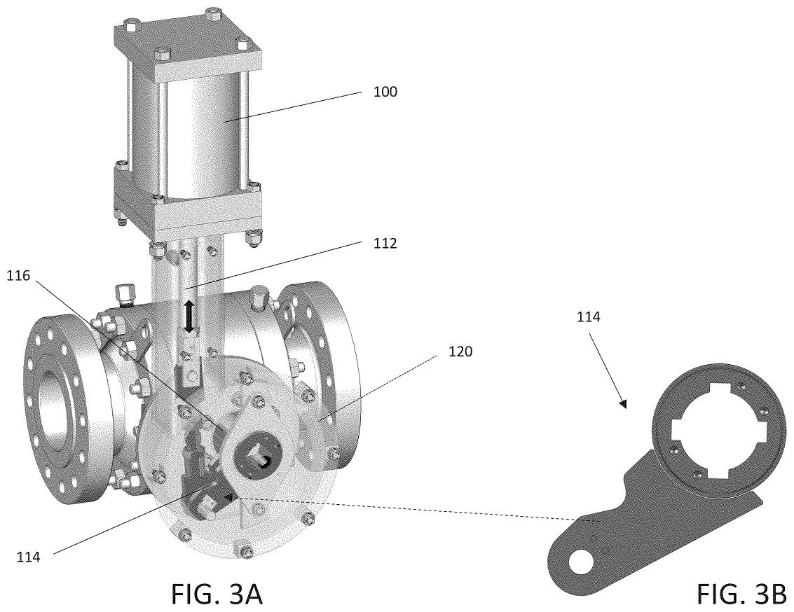

Referring first to FIGS. 1-3, schematics of above ground (FIG. 1) and below ground (FIG. 2) control valves 110 are shown. While the control valve 110 is below ground in FIG. 2, the pneumatic actuator module 100 is above ground in both systems. Further, in both systems the pneumatic linear actuator power module 100 is utilized to modulate a ball valve within the control valve 110 via crank arm 114. As shown in FIGS. 3A-3B, the pneumatic actuator power module 100 operates shaft 112 (i.e., up and down) which is connected to the crank arm 114 (FIG. 3B) within casing 120. The crank arm 114, which is configured to provide optimum torque performance with zero lost motion, connects directly to a valve stem 116 of the ball valve (see '070 Patent). The crank arm 114 has a four-position keyway 140 for increased installation flexibility. The electric and electro-hydraulic controllers of the prior art also connect directly to the valve stem 116.

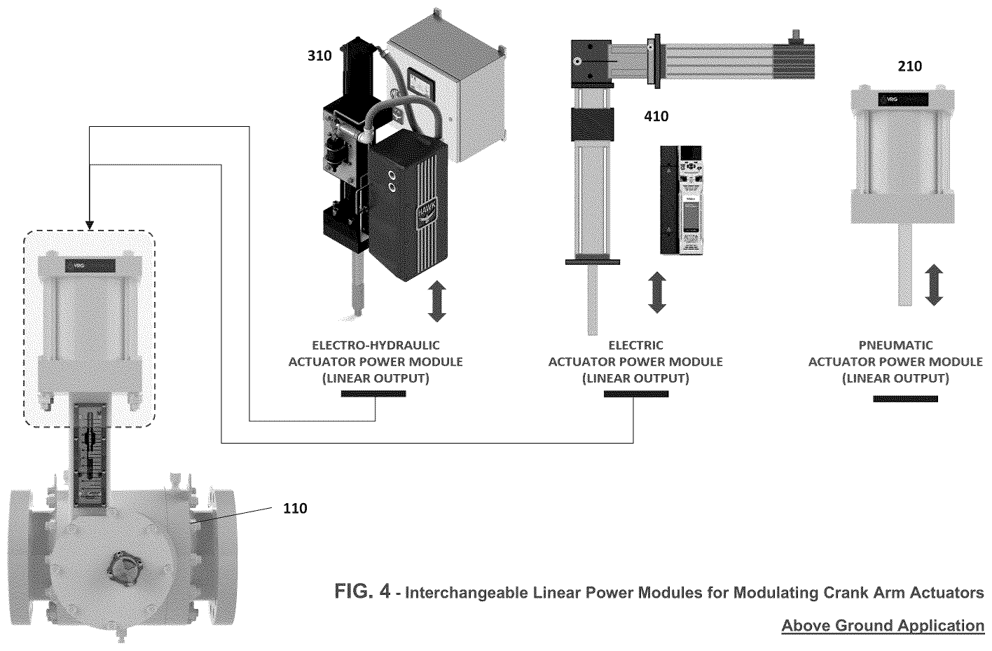

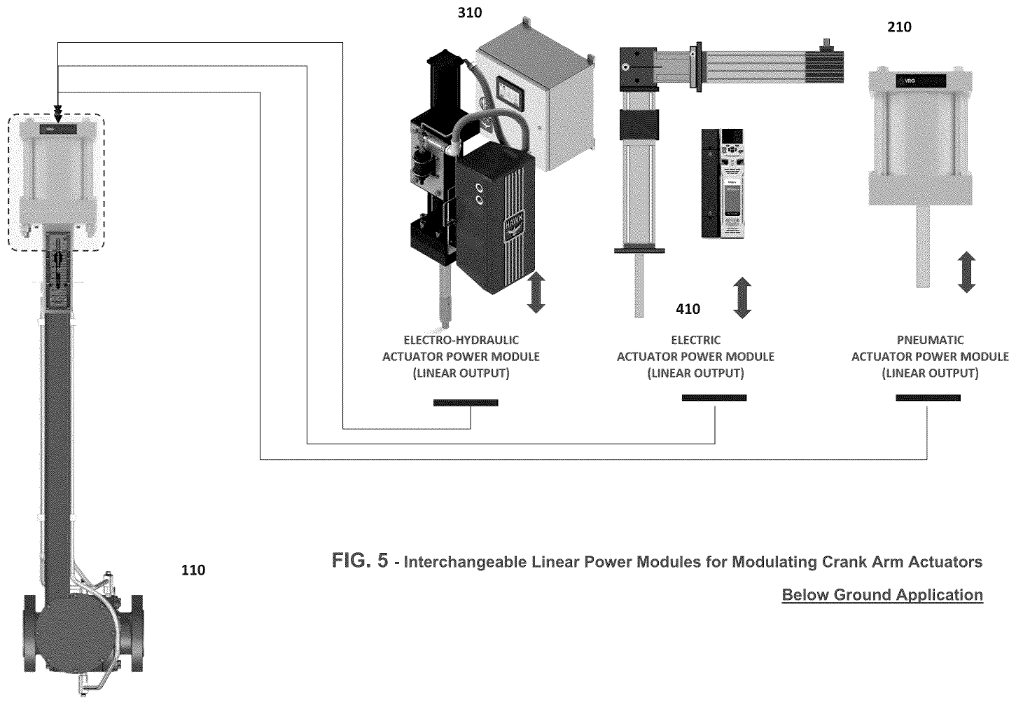

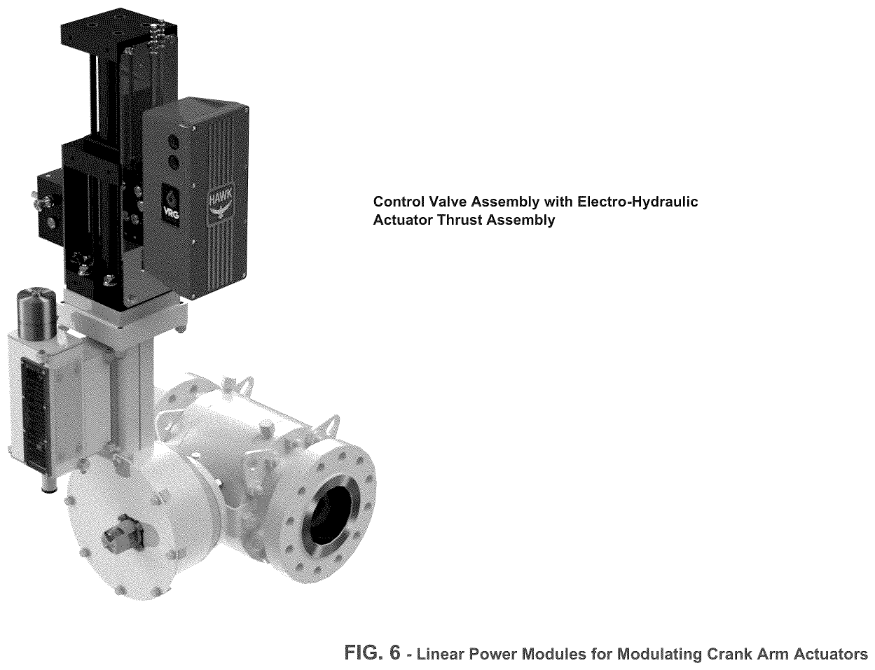

As shown in FIGS. 4-6, there is illustrated embodiments of a system of interchangeable linear power modules for modulating crank arm actuators, generally designated by the numeral X10. That is, the pneumatic module is 210, the electric module is 310, and the electro-hydraulic module is 410. The multiple embodiments of the particular illustrated system are for a natural gas line control valve, though other uses and applications may be possible.

As can be seen in the figures, the interchangeable linear power modules for modulating crank arm actuators are useful for both above and below ground applications. In many currently existing applications, a pneumatic linear actuator is currently in place. These pneumatic devices, due to fugitive emissions, are in need of being replaced. To implement the disclosed modular system, the pneumatic actuator must be removed—so as to eliminate the emissions—by disconnecting from the crank arm. At this point the linear modules 210, 310, 410 may be connected. The linear pneumatic actuator module 210 is provided because in some applications it may be necessary or desired to use pneumatic control of the valve modulation, at least initially. The module 210 can be replaced again, so as to continue the elimination of emissions.

Even when the gas line control valve is below ground, the actuator is positioned above ground. Most preferably, a linear electric module 310 or a linear electro-hydraulic (EH) actuator thrust module 410 is used to replace the pneumatic module 210 and can be adapted to connect to the existing crank-arm 114 with control valve actuator shaft 112. The actuator design is preferably “double acting,” meaning it is driven with both power to “CLOSE” and power to “OPEN” the control valve 110. Alternatively, the actuator design can be “failsafe” driven with power to “CLOSE” the control valve 110 and stored energy (e.g., a spring or accumulator) to “OPEN” the control valve. In the event of a failure, the valve will be actioned to the open position. The “failsafe” design can also be driven with power to “OPEN” and stored energy (e.g., a spring or accumulator) to “CLOSE” the control valve. Here, the valve would be actioned to the closed position in the event of a failure.

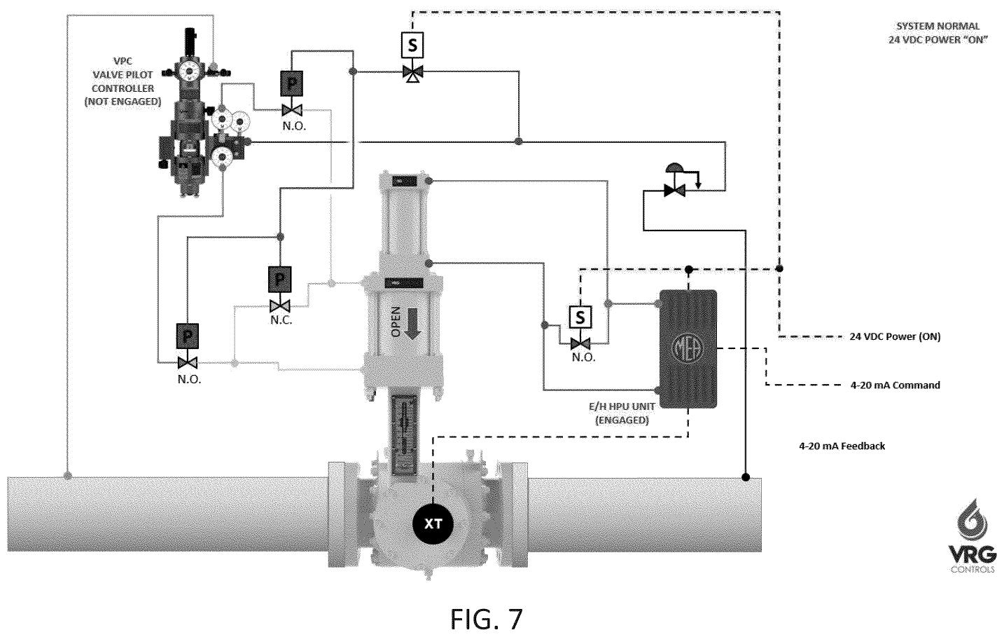

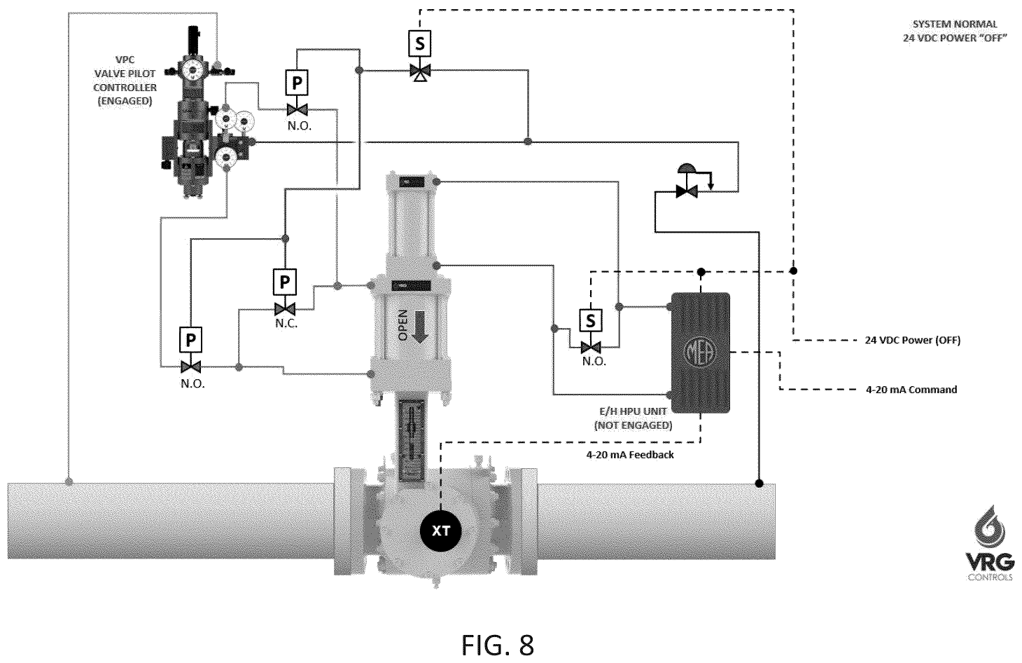

Referring now to FIGS. 7 and 8, a pneumatic piston “override” configuration is illustrated. The concept of incorporating a linear electric or electro-hydraulic actuator thrust module adapted to crank-arm control valve actuator in tandem with a pneumatic piston “override” may be used for specific applications. For example, in the event of a power failure to the electric or electro-hydraulic actuator, the pneumatic override 140 will be activated and modulate the control valve 110 until power is restored.

While all of the above disclosed configurations may be supplied as a new control system build assembly, in the case of existing pneumatic linear actuators, the above may be supplied as a backward/forward compatible adaptation with existing crank arm actuators.

Where existing crank arm actuators have been supplied by other manufacturers (i.e., not VRG Controls), these installs can accept the above electric or electro-hydraulic actuator thrust modules.

The electric module 310 and the electro-hydraulic actuator thrust module 410 retrofit is especially well suited for existing below ground installations, particularly those manufactured by VRG Controls and Becker/GE/Baker Hughes. There may be other manufacturers of crank arm actuator components that might be compatible for retrofit as well, including Metso/Flowserve/Fisher-Emerson. The retrofit concept enables interchange of the pneumatic piston and conversion to an electric/electro-hydraulic thrust drive without the need to excavate existing buried actuators. It represents the shortest path to alternate actuation without emissions.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A system for modulating a fluid line control valve having a fluid pathway connecting an inlet to an outlet, a rotatable ball valve positioned within the fluid pathway and having an opening therethrough to align with the fluid pathway, and a valve stem connected to the rotatable ball valve, extending to an exterior of the control valve, and configured to rotate the rotatable ball valve within the control valve to thereby affect alignment of the opening with the fluid pathway, the system comprising:
a torque arm actuator mechanism connected by a first end to the valve stem of the control valve; and
a linear non-pneumatic actuator module having a piston configured to move along a line normal to an axis of the valve stem, the piston being connect to a second end of the torque arm actuator mechanism such that linear movement of the piston causes rotational movement of the first end of the torque arm actuator mechanism and the connected valve stem;
wherein the linear actuator module operates to move the piston along the line normal to the axis of the valve stem and thereby alter the alignment of the opening of the rotatable ball with the fluid pathway.

2. The system of claim 1, wherein the linear actuator module is one of either an electric driven actuator or an electro-hydraulic driven actuator.

3. The system of claim 2, wherein the linear actuator module is interchangeable between the electric driven actuator and the electro-hydraulic driven actuator.

4. The system of claim 1, further comprising a pneumatic override actuator.

5. The system of claim 1, wherein the control valve is positioned below ground and the linear actuator is positioned above ground.

6. The system of claim 1, wherein the linear actuator comprises an electro-hydraulic linear actuator.

7. The system of claim 6, wherein the electro-hydraulic linear actuator comprises a pneumatic linear actuator override.

8. The system of claim 1, wherein the first end of the torque arm actuator mechanism comprises a four-position stem key for adjusting to allow attachment to the valve stem of the control valve.

9. The system of claim 2, wherein the linear actuator module is double-acting with power to both close and open the control valve.

10. The system of claim 2, wherein the linear actuator module is single-acting with power to open the control valve.

11. The system of claim 10, further comprising a stored energy device coupled to the valve stem to close the control valve.

12. The system of claim 2, wherein the linear actuator module is single-acting with power to close the control valve.

13. The system of claim 12, further comprising a stored energy device coupled to the valve stem to open the control valve.

14. A method for eliminating gas emissions resulting from operation of pneumatic actuators for a control valve in natural gas pipeline control systems, the control valve having a valve stem and configured to move from a fully open to a fully closed position via turning of the valve stem, the method comprising:
disconnecting a pneumatic actuator from a piston shaft connected to a crank arm which is connected to a valve stem of a control valve in a natural gas pipeline;
removing the pneumatic actuator;
attaching a replacement linear actuator module comprising one of either an electric actuator module or an electro-hydraulic actuator module to the piston shaft connected to a crank arm; and
operating the replacement linear actuator module to modulate the control valve in the natural gas pipeline.

15. The method of claim 14, further comprising providing a pneumatic linear override actuator.
